(19) United States
(12) Patent Application Publication
(10) Pub. No.: US 2009/0042602 A1
(43) Pub. Date: Feb. 12, 2009

(54) MOBILE TERMINAL

(75) Inventors: Keisuke Nagata, Osaka (JP); Norihito Imanaka, Nara (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: SANYO ELECTRIC CO., LTD., Moriguchi-shi, Osaka (JP)

(21) Appl. No.: 11/815,906

(22) PCT Filed: Feb. 8, 2006
(86) PCT No.: PCT/JP2006/302144

§ 371 Date: Aug. 9, 2007

(30) Foreign Application Priority Data
Feb. 9, 2005 (JP) 2005-033679

(51) Int. Cl. H04M 1/00

(52) U.S. Cl. 455/556.1

(57) ABSTRACT

A mobile terminal has a plurality of functions executed by a press of a specific key, and an address book that stores personal information. The personal information includes a plurality of personal information pieces composed of mail destinations and execution information necessary for executing the functions. When the mobile telephone receives designation of a mail that has been transmitted or received, or is to be transmitted, and any of the keys is pressed, a personal information pieces that includes a destination that is the receiver or transmitter of the designated mail is retrieved from the address book. Execution information of the function allocated to the pressed key is retrieved, and the function allocated to the pressed key is executed.

### TECHNICAL FIELD

The present invention relates to improving operability of a mobile terminal having a plurality of functions, one of which is an electronic mail communication function that enables communication using electronic mail. The present invention particularly relates to a technique for improving operability during use of the electronic mail communication function.

### BACKGROUND ART

In recent years mobile terminals such as mobile telephones have come to have various functions, including a voice communication and an electronic mail (herein after referred to simply as mail) communication function.

To use such functions, it is often necessary to first return to an initial screen, and then select and execute the desired function. For instance, if a user is reading a mail from a person and wishes to call that person, the user must first close the mail and return to the stand-by screen, then search an address book for the telephone number of the person to call the person.

In the interests of saving time, techniques have been developed whereby call processing is included in a list of processing that can be performed for incoming mail, and a call can be initiated to the sender of the mail from the listing (see Patent Document 1).

Patent Document 1: Japanese Patent Application Publication No. 2002-77451

### DISCLOSURE OF THE INVENTION

### Problem to be Solved by the Invention

However, these days one person has a plurality of telephone numbers, such as those of a work telephone, a home telephone and a mobile telephone. One person also has a plurality of mail addresses, such as those of a work computer, a home computer and a mobile telephone.

Consequently, if a user wishes to reply to the sender of an incoming mail in some way, the user may need or wish to change the destination depending on the situation.

In view of this, the present invention has a feature of providing a mobile telephone terminal of performing processing in accordance with the wishes of the user simply, when performing communication relating to a mail during usage of the electronic mail communication function.

### Means to Solve the Problem

In order to solve the stated problem, the present invention is a mobile terminal having a plurality of functions including a mail function, and having a plurality of keys, each of which a different one of the functions is allocated to, the mobile terminal including: an address book operable to store, in correspondence, destination information pieces and related information pieces, each destination information piece being information at least identifying an opposite party of mail, and each related information piece being information relating to the opposite party identified by the corresponding destination information piece; and a retrieval unit operable to, when a designation of one of (i) a mail that has been received, (ii) a mail that has been transmitted, and (iii) a mail that is to be transmitted is received and any one of the keys is pressed, retrieve from the address book, one or more related information pieces in correspondence with one of the destination information pieces that identifies an opposite party of the designated mail.

### TECHNICAL ADVANTAGES OF THE INVENTION

Furthermore, the present invention is a mobile terminal having a plurality of functions including a mail function, and having a plurality of keys, each of which a different one of the functions is allocated to, the mobile terminal including: an address book operable to store, in correspondence, at least one or more mail addresses and one or more telephone numbers; and a retrieval unit operable to, when a designation of one of (i) a mail that has been received, (ii) a mail that has been transmitted, and (iii) a mail that is to be transmitted is received and any one of the keys is pressed, retrieve from telephone numbers in the address book, a telephone number in correspondence with a mail address of the designated mail.

According to the stated structure, when a mail is being displayed or the like, with a press of a predetermined key, the mobile terminal of the present invention automatically retrieves information that is necessary for processing executed by the pressed key and that relates to the sender or receiver of the mail being displayed or the like. Therefore, a mobile terminal can be easily produced that enables the user to execute a desired function with few operations.

Here, the mobile terminal may further include: a display unit operable to display at least one of the retrieved related information pieces.

Furthermore, the mobile terminal may further include: a designation unit operable to designate one of the displayed related information pieces; and a control unit operable to cause commencement of a function allocated to the pressed key, based on the designated related information piece.

According to the stated structure, when a key is pressed, the information necessary for processing executed by the pressed key is automatically retrieved and presented to the user. Therefore, the user is able to execute a desired function with few operations.

More specifically, if a plurality of information pieces necessary for processing executed by the pressed key exist, all the pieces are presented to the user. Therefore, the user is able to perform processing such as call processing taking the time of day, situation etc. into consideration.

Furthermore, the mobile terminal may further include: a control unit operable to cause commencement of a function allocated to the pressed key, based on the one or more retrieved related information pieces.

According to the stated structure, when a key is pressed, the information necessary for processing executed by the pressed key is automatically retrieved and a function is executed based on the information. Therefore, the user is able to execute a desired function with few operations.

Furthermore, the function allocated to the pressed key may be a call initiation function, each of the one or more related information pieces retrieved by the retrieval unit may be a telephone number, and the control unit may cause commencement of the call initiation function to initiate a call to one of the retrieved telephone numbers.

According to the stated structure, if the call key is pressed when a mail is being displayed, a list of telephone numbers of the sender or receiver of the mail is presented. Therefore, the user is able to perform processing such as call processing easily taking the time of day, situation etc. into consideration.

Furthermore, the function allocated to the pressed key may be a mail transmission function, each of the one or more related information pieces retrieved by the retrieval unit is may be a mail address, and the control unit may cause commencement of the mail transmission function to transmit a mail to one of the retrieved mail addresses.

Furthermore, the function allocated to the pressed key may be a short message function for sending a predetermined type of mail, each of the one or more related information pieces retrieved by the retrieval unit may be a telephone number, and the control unit may cause commencement of the short message function to transmit the predetermined type of mail to one of the retrieved telephone numbers.

According to the stated structure, if the mail key is pressed when a mail is being displayed, a list of mail addresses and/or telephone numbers of the sender or receiver of the mail is presented. Therefore, the user is able to send an electronic mail or a short message easily taking the time of day, situation etc. into consideration.

Furthermore, the function allocated to the pressed key may be a web page display function, each of the one or more related information pieces retrieved by the retrieval unit may be an address of a web page, and the control unit may cause commencement of the web display function to display a web page of one of the extracted addresses

According to the stated structure, if the web key is pressed when a mail is being displayed, a list of one or more URLs of web pages relating to the sender or receiver of the mail is presented. Therefore, the user can easily view one or more of the web pages.

### BRIEF DESCRIPTION OF THE DRAWINGS

FIG. 1 is a function block diagram showing the structure of a mobile terminal;

FIGS. 2A and 2B show examples of personal information 420, with FIG. 2A showing an example of personal information having a registration number “038”, and FIG. 2B showing an example of personal information having registration number “067”;

FIGS. 3A and 3B show an example of contents and display of data of an incoming mail, with FIG. 3A showing an example of contents of reception information 610 of incoming mail, and FIG. 3B showing an example of the incoming mail being displayed on a display 310;

FIGS. 4A and 4B show an example of contents and display of data of an outgoing mail, with FIG. 4A showing an example of contents of transmission destination information 650, and FIG. 4B showing an example of the outgoing mail being displayed on the display 310;

FIG. 5 is a flowchart showing processing when a call key 210 is pressed while incoming mail is being displayed;

FIG. 6 is a flowchart showing processing when a mail key 220 is pressed while incoming mail is being displayed;

FIG. 7 is a flowchart showing processing when a web key 230 is pressed while incoming mail is being displayed;

FIG. 8 is a flowchart showing processing when a call key 210 is pressed while outgoing mail is being displayed;

FIG. 9 is a flowchart showing processing when a mail key 220 is pressed while outgoing mail is being displayed; and

FIG. 10 is a flowchart showing processing when a web key 230 is pressed while outgoing mail is being displayed.

### DESCRIPTION OF NUMERICAL REFERENCES

10 Antenna
20 Radio unit
30 Modulation/demodulation unit
40 Voice processing unit
50 Microphone
60 Speaker
100 Control unit
200 Key operation detection unit
210 Call key
220 Mail key
230 Web key
300 Display unit
310 Display
400 Address book search unit
Address book storage unit
420 Personal information
421 Management number
500 Voice communication function unit
600 Mail transmission/reception function unit
700 Short message transmission/reception function unit
800 Web access unit
1000 Mobile terminal

### DESCRIPTION OF THE PREFERRED EMBODIMENT

<Overview>

With the mobile terminal of the embodiment of the present invention, during use of a mail communication function or the like, other functions can be performed with respect to the sender or the like of the mail currently being processed with just a press of a corresponding key. In addition, the wishes of the user can be easily reflected when using the function.

For instance, while the user is reading an incoming mail and wishes to call the sender of the mail, by simply pressing a call key, a list of telephone numbers of the sender are displayed. If, for instance, it is the evening and the user therefore decides that the call should be made to the home of the sender, the user can make the call to the home telephone number of the sender.

In relation to the embodiment of the present invention, the term mail address denotes the mail address of a sender or the like relating to a mail or the like currently being processed.

In other words, in the case of an incoming mail, the term mail address includes a destination to which the same mail was transmitted and a destination to which the same mail was transmitted by CC (carbon copy). Similarly, in the case of an outgoing mail, the term mail address includes all destinations to which the same mail is transmitted and a destination to which the same mail was transmitted by CC.

In the present embodiment, a description is given of a mobile telephone having functions such as a voice communication function in addition to the mail transmission function.

<Structure>

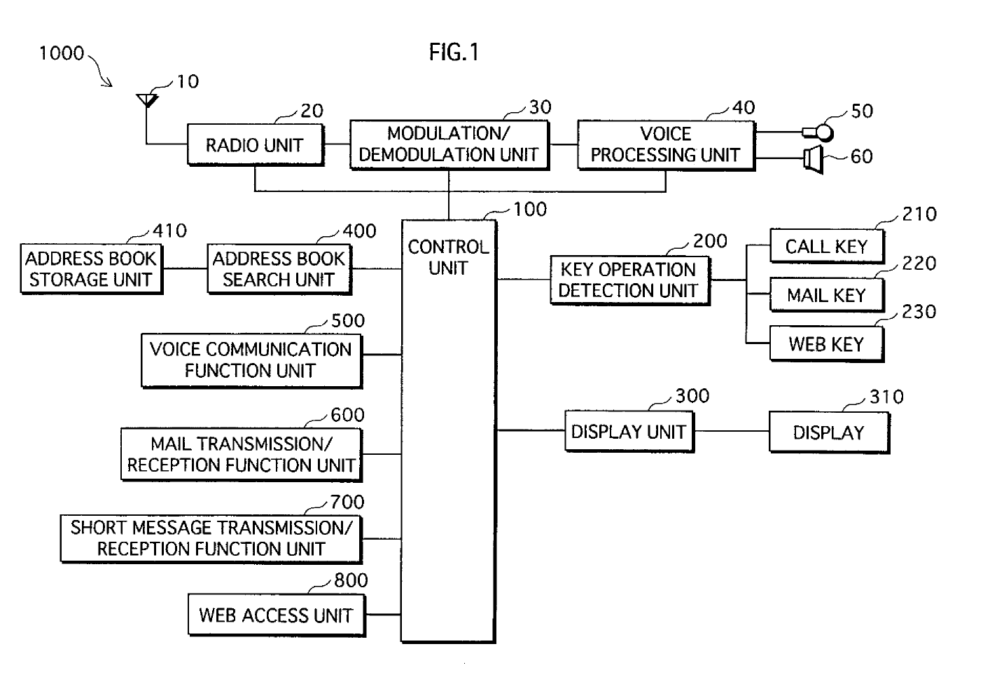

The following describes a mobile telephone of the present embodiment with use of FIG. 1.

FIG. 1 is a function block diagram showing the structure of the mobile telephone.

A mobile telephone 1000 includes an antenna 10; a radio unit 20 that includes a high frequency circuit; a modulation/demodulation unit 30 that includes a modulation/demodulation circuit and a signal processing circuit; a voice processing unit 40 that performs digital-analog conversion of audio signals; a speaker 60 that outputs a voice signal; a microphone 50 that receives input of external sound; a control unit 100; a key operation detection unit 200; a call key 210; a mail key 220; a web key 230; a display unit 300; a display 310; an address book search unit 400; a address book storage unit 410; a voice communication function unit 500; a mail transmission/reception function unit 600; a short message transmission/reception function unit 700; and a web access unit 800.

The control unit 100 has a CPU, a memory and the like (not illustrated). In addition to performing communication processing and other general control processing necessary in the mobile telephone, the control unit 100 performs control processing characteristic of the present invention.

Of the voice communication functions, the call function is allocated to the call key 210.

Allocated to the mail key 220 are an electronic mail transmission/reception function (herein after called a mail transmission/reception function) and short message transmission/reception function. Which of these two functions is being instructed is determined according to how long the mail key 220 is pressed. When the mail key 220 is pressed for longer than a predetermined time (herein after referred to as a “long press”) it is determined that the short message transmission/reception function is being instructed. When the mail key 220 is pressed for less than the predetermined time (herein after referred to as a “short press”), it is determined that the mail transmission/reception function is being instructed.

Allocated to the web key 230 is a function of connecting to the Internet, and a function of displaying a predetermined web page. The key operation detection unit 200 has a function of detecting that a key has been pressed, and notifying the control unit 100 of the function allocated to the pressed key.

Although three keys, namely the call key 210, the mail key 220 and the web key 230 are illustrated here, the mobile telephone 1000 also has other keys generally provided on a mobile telephone, such as an OK key and numeric keys. The key operation detection unit 200 also has the function of detecting a press of any of these keys, and notifying the control unit 100.

The display unit 300 has a function of displaying data received from the control unit 100 on the display 310.

The address book search unit 400 has a function of searching the address book using as a key a mail address, telephone number or the like received from the control unit 100.

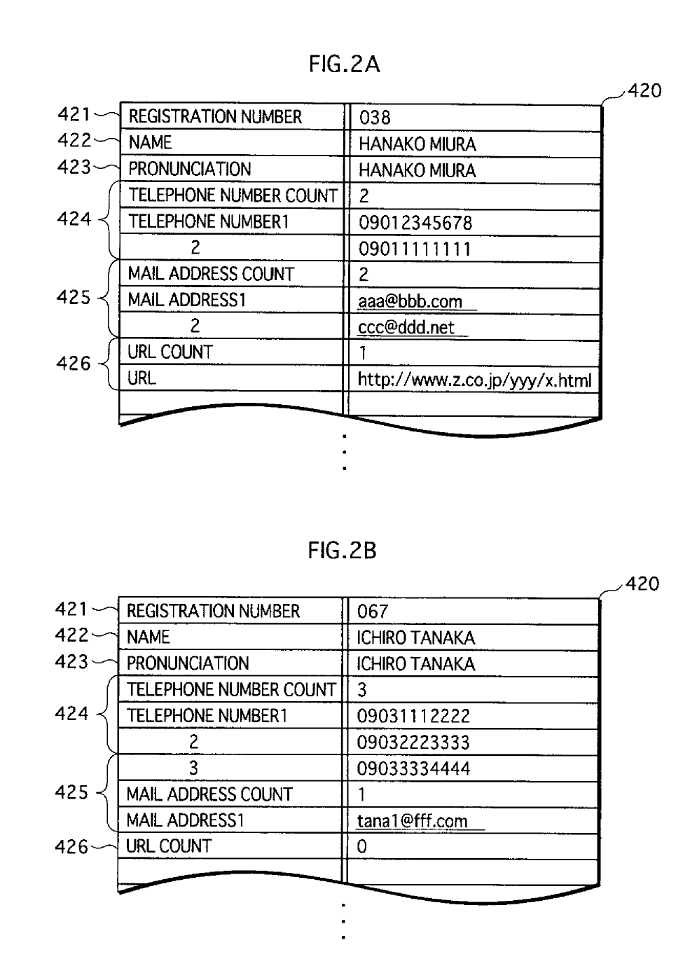

The address book is a collection of personal information, and is for managing various personal information such as telephone numbers, and mail addresses that are destinations of mail. Details of the address book are given later with use of FIG. 2.

The address book is stored in the address book storage unit 410.

The voice communication function unit 500 has a voice communication function. This voice communication function is, in other words, a telephone function.

The mail transmission/reception function unit 600 has functions such as creation, transmission/reception and editing of mail.

The short message transmission/reception function unit 700 has a function of transmitting/receiving mail that is a short text message sent between mobile telephones. The main difference with the mail transmission/reception function unit 600 is that the mail transmission/reception unit 600 transmits mail to an mail address, where as the short message transmission/reception function unit 700 transmits mail to a telephone number.

The web access unit 800 has a function of accessing a web page on the Internet, and displaying the web page on the display 310. The web access unit 800 has the web page displayed by issuing a request to display unit 300 the via the control unit 100.

Here, the part or all of the processing by the control unit 100 and the other units is realized by the CPU executing various programs.

<Data>

The following describes the main data used in the mobile telephone 1000, with use of FIG. 2 to FIG. 4.

FIGS. 2A and 2B shows an example of personal information 420.

FIG. 2A is an example of personal information having a registration number “038”, and FIG. 2B is an example of personal information having a registration number 067.

An example of the personal information 420 being personal information pertaining to person is given in the present embodiment. However, this information is not limited to being that of a person, and may instead be individual information pertaining to another entity such as a shop, a school, or a company.

The personal information 420 constitutes the address book stored in the address book storage unit 410, and is stored in the address book storage unit 410.

The personal information 420 includes a registration number 421, a name 422, a pronunciation 423, telephone number information 424, mail address information 425, and URL information 426.

The registration number 421 is an identification number of the personal information 420.

The name 422 is a name identifying the individual shown by the personal information 420, and the pronunciation 423 shows how the name is pronounced.

The mobile telephone information 424 is the telephone number or numbers of the individual shown by the personal information 420, and includes the telephone number or numbers, and a telephone number count showing how many telephone numbers are included in the personal information 420.

Similarly, the mail address information 425 is the mail address or addresses of the individual shown by the personal information 420, and includes the mail address or addresses, and a mail address count showing how many mail addresses are included in the personal information 420.

The URL information 426 is a web page or pages relating to the individual shown by the personal information 420, and includes the URL or URLs and a URL count showing how many web pages are included in the personal information 420.

As one example, the individual registered with “038” as the registration number 421 is “Hanako Miura” in the name 422, and has two telephone numbers shown by a count “2” (see FIG. 2A).

Note that the “telephone number 1” and the “mail address 1” are a regular telephone number and mail address (i.e. the telephone number and mail address usually used).

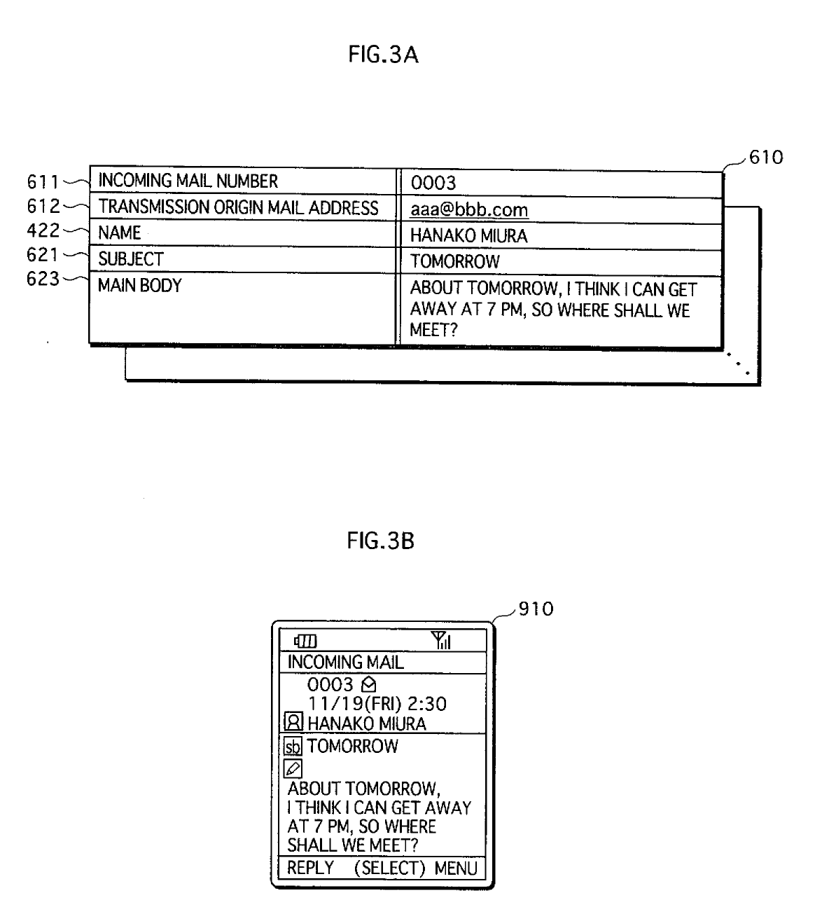

FIGS. 3A and 3B show an example of contents and display of data of an incoming mail.

FIG. 3A is an example of reception information 610 of incoming mail. FIG. 3B shows an example of display of the incoming mail on the display 310.

The received information 610 of the incoming mail is stored in a memory in the mail transmission/reception function unit 600, and is managed by the mail transmission/reception function unit 600. The memory is capable of storing a predetermined number of incoming mails.

The received information 610 of the incoming mail (FIG. 3A) includes an incoming mail number 611, a transmission origin mail address 612, a name 422, a subject 621, a main body 622, and a reception date and time (not illustrated).

The reception mail number 611 is an identification number of the incoming mail. Basically, an incoming mail number 611 is assigned to each incoming mail in ascending order in order of reception.

The transmission origin mail address 612 is the mail address that is the origin of transmission of the incoming mail.

The name 422 is a name registered in the personal information 420 in correspondence with the same mail address as the transmission origin mail address 612. The name 422 is retrieved from the address book and set when generating the reception information 610 of the incoming mail. The name 422 is blank when no corresponding mail address is registered in the address book.

The subject 621 is the title of the incoming mail, and the main body 623 is the actual message being communicated by the incoming mail.

For instance, an incoming mail with 0003 as the incoming mail number 611 has a transmission origin mail address 612 “aaa@bbb.com”, and has been sent from a name “Hanako Miura”. In terms of the message being communicated, the subject 621 is “tomorrow”, and the main body 623 is “About tomorrow . . . ”

A screen 910 is the screen displayed on the display 310 when displaying the incoming mail having 0003 as the incoming mail number 611.

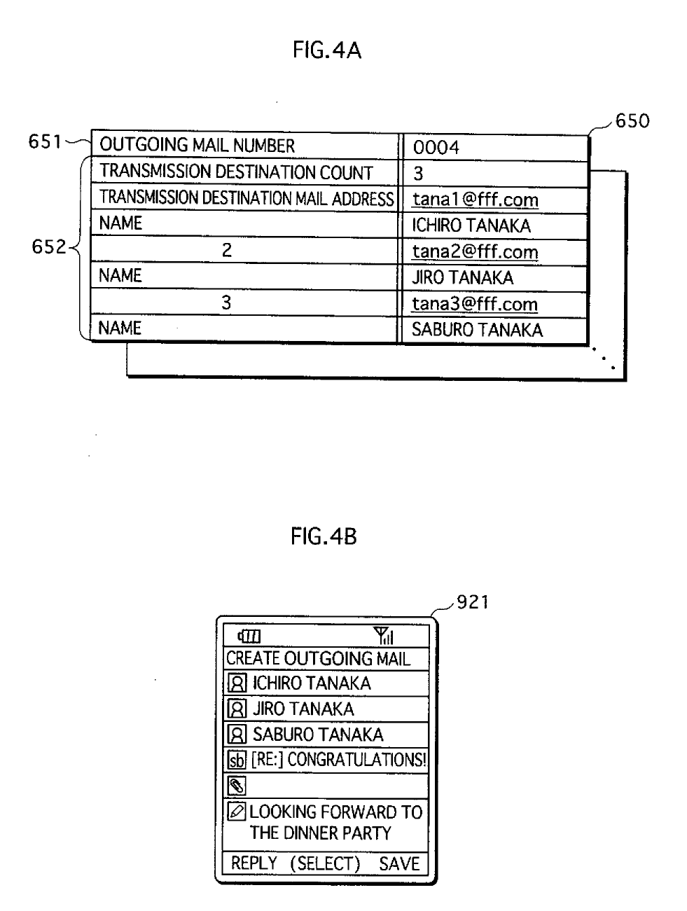

FIGS. 4A and 4B show an example contents and display of data of an outgoing mail.

FIG. 4A is an example of transmission destination information 650 of outgoing mail. FIG. 48 shows an example of display of the outgoing mail on the display 310.

The transmission destination information 650 of the incoming mail is stored in a memory in the mail transmission/reception function unit 600, and is managed by the mail transmission/reception function unit 600. The memory is capable of storing a predetermined number of outgoing mails.

The transmission destination information 650 of the outgoing mail includes an outgoing mail number 651, and transmission addressee information 652.

The outgoing mail number 651 is a an identification number of the outgoing mail. Basically, an outgoing mail number 651 is assigned to each outgoing mail in ascending order in order of transmission.

The transmission addressee information 652 shows one or more of transmission destinations of the outgoing mail. The transmission addressee information 652 includes a transmission destination count that is how many destinations the outgoing mail was transmitted to, the mail address or addresses that are the transmission destination or destinations, and a name or names. Note that any outgoing mails transmitted by CC (carbon copy) are included.

For instance, the outgoing mail having 0004 as the outgoing mail number 651 has a transmission destination count “3”. The transmission destination mail addresses are “tana1@fff.com”, “tana2@fff.com” and “tana3@fff.com”. The names are “Iciro Tanaka”, “Jiro Tanaka” and “Saburo Tanaka”.

A screen 921 is the screen displayed on the display 310 when displaying the outgoing mail having 0004 as the incoming mail number 651.

The data pertaining to the mail shown in FIGS. 3A and 3B and FIGS. 4A and 4B is data pertaining to mail transmitted and received by the mail transmission/reception function unit 600. The mail transmitted and received by the short message transmission/reception function unit 700 is basically the same as the described data, and differs only in that the transmission origin mail address 612 and the transmission destination mail address (the transmission destination mail addresses of the transmission destination count 652) are telephone numbers.

<Operations>

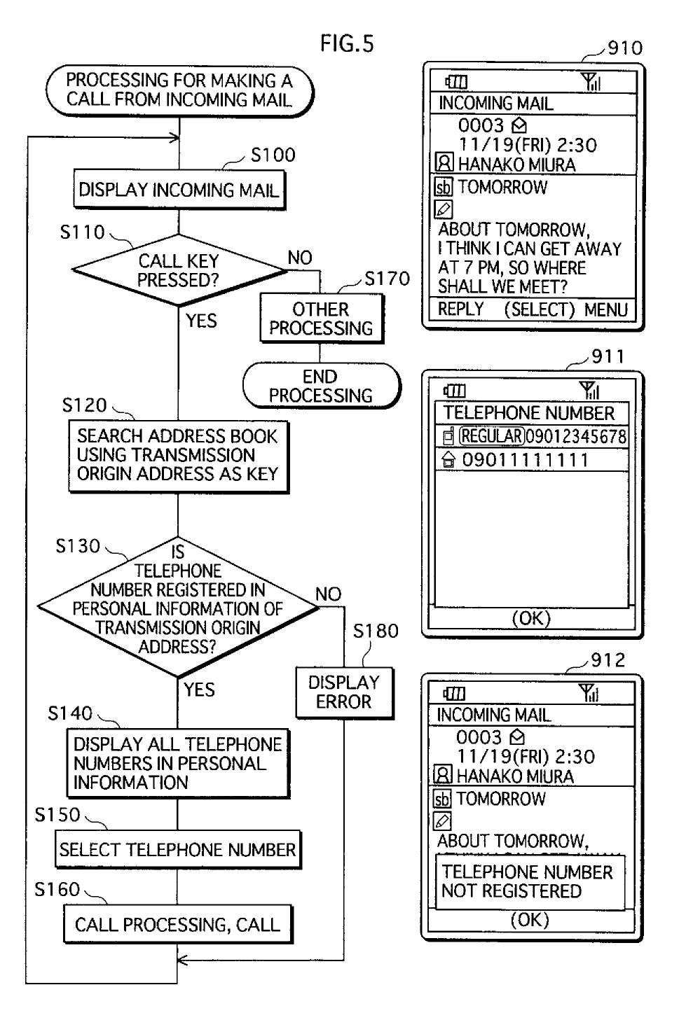

The following describes operations of the described mobile telephone 1000 with use of FIG. 5 to FIG. 10.

Separate descriptions are given of processing relating to an incoming mail when that incoming mail is designated, and processing relating to an outgoing mail when that outgoing mail is designated.

Here, designating an incoming mail denotes not only a case of displaying the main body and the like of the incoming mail, but also a case of designating one incoming mail in a list by focusing on that incoming mail, or a case of selecting the incoming mail using the OK key or the like.

Similarly, designating an outgoing mail denotes not only displaying the message of a mail transmitted in the past or in the process of being created, but also a case of designating one outgoing mail in a list by focusing on that outgoing mail, or a case of selecting the outgoing mail using the OK key or the like.

Note that the drawings shown to the right of the flowcharts (910, 911, etc.) are examples of screens displayed on the display 310 of the mobile telephone 1000.

<1. When an Incoming Mail is Designated>

The following describes processing in cases of each of keys 210, 220 and 230 being pressed when an incoming mail is designated.

<1-1. When the Call Key is Pressed>

FIG. 5 is a flowchart showing processing in the case of the call key 210 being pressed when an incoming mail is being displayed.

Here, the incoming mail is either a mail received by the mail transmission/reception function unit 600 or a mail received by the short message transmission/reception function unit 700.

First the case of the mail being a mail received by the mail transmission/reception function unit 600 is described.

The user performs an operation to display the incoming mail.

The key operation detection unit 200 detects that the user has performed an operation to display a mail, and notifies the control unit 100 of the detection and the incoming mail number of the designated mail.

Having received the notification, the control unit 100 notifies the mail transmission/reception function unit 600 of the incoming mail number, and requests that the incoming mail be displayed.

Having received the request to display the incoming mail, the mail transmission/reception function unit 600 searches the reception information 610 of incoming mail stored in the internal memory for the incoming mail number notified by the control unit 100. If an incoming mail number that matches the notified incoming mail number exists in the reception information 610, the mail transmission/reception function unit 600 notifies the display unit 300, via the control unit 100, of the content of the incoming mail corresponding to the matching incoming mail number, and requests the display unit 300 to display the content.

At this time, the control unit 100 stores the transmission origin mail address 612 corresponding to the incoming mail number in a working memory.

Having received the display request, the display unit 300 displays the notified content on the display 310 (step S100, screen 910).

In this state, the user presses the call key 210 (step S110: YES).

The key operation detection unit 200 detects that the call key 210 has been pressed, and notifies the control unit 100 that the function allocated to the pressed key is the voice communication call function.

If any other key is pressed, the key operation detection unit 200 notifies the control unit 100 of the processing allocated to the pressed key (step S110: NO), and the processing is executed (step S170).

The control unit 100 receives notification from the key operation detection unit 200 that the voice communication call function has been instructed by the user. The control unit 100 then notifies the address book search unit 400 of the transmission origin mail address stored in the working memory, in other words, the transmission origin mail address 612 of the currently displayed incoming mail, and issues a request to the address book search unit 400 to search for corresponding telephone numbers.

Having received the search request, the address book search unit 400 performs a search of the address book stored in the address book storage unit 410 using the notified transmission origin mail address 612 as a key (step S120). The address book search unit 400 then selects the personal information 420 that includes a mail address the same as the transmission origin mail address 612.

The address book search unit 400 retrieves all telephone numbers from the selected personal information 420 (step S130: YES), and returns the retrieved one or more telephone numbers to the control unit 100.

As one example, when the transmission origin mail address 612 is “aaa@bbb.com”, the personal information 420 having “038” as the registration number 412 is selected, and two telephone numbers, namely “09012345678” and “09011111111”, are retrieved.

The control unit 100 provides the telephone numbers received from the address book search unit 400 to the display unit 300, and requests the display unit 300 to display the telephone numbers. At this time, the control unit 100 stores the telephone numbers in the working memory.

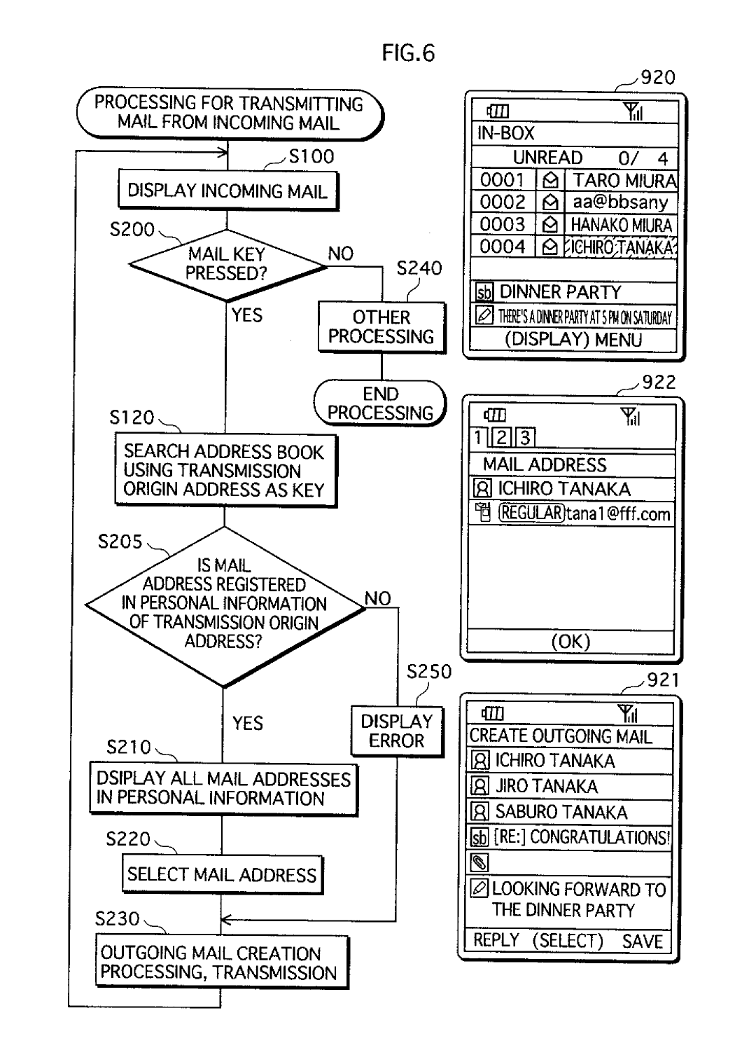

Having received the telephone number display request, the display unit 300 displays the telephone numbers on the display 310 (screen 911). When there are plural transmission origins and a plurality of people as transmission destinations, telephone numbers equal in number to the plurality of people are displayed in pages such as displayed in the screen 922 in FIG. 6, which can be flipped through to select a telephone number.

The user performs an operation to focus on one of the displayed telephone numbers and presses the OK key (step S150).

The key operation detection unit 200 detects that the OK key has been pressed, and notifies the control unit 100 of the press and which number telephone number is being focused on.

The control unit 100 receives the notification, and retrieves the telephone number being focused on from the working memory. The control unit 100 then notifies the voice communication function unit 500 of the retrieved telephone number, and issues a request to the audio communication function unit 500 to initiate a call.

Having received the call request, the voice communication function unit 500 performs call initiation processing using the received telephone number as a destination of the call, and performs call processing (step S160).

When the call ends, the voice communication function unit 500 notifies the control unit 100 to this effect. The control unit 100 receives the notification, and displays the incoming mail (step S100).

Note that when the address book search unit 400 is unable to select the personal information 420, or when telephone numbers are not registered in the selected personal information, the address book search unit 400 notifies the control unit 100 to this effect, and the control unit 100 issues a request to the display unit 300 to display a message to this effect.

The display unit 300 receives the message display request, and displays an error message on the display 310 (step S180, screen 912).

Next, a description is given of a case in which the incoming mail is mail received by the short message transmission/reception function unit 700.

The processing in this case is basically the same as when the incoming mail is mail received by the mail transmission/reception function unit 600, but differs as follows.

The difference when the incoming mail is mail received by the short message transmission/reception function unit 700 instead of mail received by the mail transmission/reception function unit 600 is that the control unit 100 stores a telephone number instead of a mail address, and it is the telephone number, not the mail address, that the address book search unit 400 uses as a key when searching the address book (step S120).

<1-2. When the Mail Key is Pressed>

FIG. 6 is a flowchart showing processing in the case of the mail key 220 being pressed when an incoming mail is being displayed.

Here, the incoming mail is either a mail received by the mail transmission/reception function unit 600 or a mail received by the short message transmission/reception function unit 700.

First the case of the incoming mail being a mail received by the mail transmission/reception function unit 600 is described.

The user performs an operation to display the incoming mail, and the incoming mail instructed by the user is displayed (step S100, screen 920). In the present embodiment, a list of mails that have been received is displayed.

The processing to display the incoming mail is the same as the processing at step S100 of FIG. 5.

In this state, the user presses the mail key 220 (step S200: YES). Here, it is assumed that instead of identifying whether the press is a long press or a short press, which of the mail reception/transmission function and the short message reception/transmission function has been instructed depends on the incoming mail being displayed. In other words, when the incoming mail being displayed is mail received by the mail transmission/reception function unit 600, it is judged that the mail transmission/reception function has been instructed.

The key operation detection unit 200 detects that the mail key 220 has been pressed, and notifies the control unit 100 that the function assigned to the pressed key is the mail transmission/reception function.

If any other key is pressed, the key operation detection unit 200 notifies the control unit 100 of the processing allocated to the pressed key (step S200: NO), and the processing is executed (step S240).

The control unit 100 receives notification that the mail transmission/reception function has been instructed by the user. The control unit 100 then notifies the address book search unit 400 of the transmission origin mail address 612 of the currently displayed incoming mail, and issues a request to the address book search unit 400 to search for corresponding mail addresses.

Having received the search request, the address book search unit 400 performs a search of the address book stored in the address book storage unit 410 using the notified transmission origin mail address 612 as a key (step S120). The address book search unit 400 then selects the personal information 420 that includes a mail address the same as the transmission origin mail address 612. The address book search unit 400 retrieves all mail addresses from the selected personal information 420 (step S205: YES), and returns the retrieved one or more mail addresses to the control unit 100.

As one example, when the transmission origin mail address 612 is “tana1@fff.com”, the personal information 420 having “067” as the registration number 421 is selected, and one mail address, namely “tana1@fff.com” is retrieved.

The control unit 100 provides the mail address received from the address book search unit 400 to the display unit 300, and requests the display unit 300 to display the mail address. At this time, the control unit 100 stores the mail address in the working memory.

Having received the mail address display request, the display unit 300 displays the mail address on the display 310 (step S210, screen 922).

Here, the address book search unit 400 is not limited to searching the personal information stored in the address book storage unit 410 using only the transmission origin mail address 612 as a key. The address book search unit 400 may search the personal information using the mail address of a person or people relating to the incoming mail, for instance a person to whom the same mail has been transmitted or a person to who a CC has been transmitted.

Telephone numbers equal in number to the people are displayed in pages such as displayed in the screen 922 in FIG. 6, which can be flipped through to select a telephone number.

The user performs an operation to focus on one of the displayed mail addresses and presses the OK key (step S220).

The key operation detection unit 200 detects that the OK key has been pressed, and notifies the control unit 100 of the press and which number mail address is being focused on.

The control unit 100 receives the notification, and retrieves the mail address being focused on from the working memory. The control unit 100 then notifies the mail transmission/transmission function unit 600 of the retrieved mail address, and issues a request to the mail transmission/transmission function unit 600 to create mail.

Having received the mail creation request, the mail transmission/transmission function unit 600 performs processing to create and transmit a new mail (step S230, screen 931).

When mail transmission ends, the mail transmission/transmission function unit 600 notifies the control unit 100 to this effect. The control unit 100 receives the notification, and displays the incoming mail (step S100).

Next, a description is given of the case of the incoming mail being mail received by the message transmission/reception function unit 700.

The difference when the incoming mail is mail received by the short message transmission/reception function unit 700 instead of mail received by the mail transmission/reception function unit 600 is that the control unit 100 stores a telephone number instead of a mail address, and that the control unit 100 issues the outgoing mail creation request to the short message transmission/reception function unit 700, not the mail transmission/reception function unit 600 (step S230).

Note that the mail key described in the present embodiment differs from a conventional key for creating a reply mail (herein after referred to as a reply key) as follows.

A reply key is for creating an outgoing mail to the original mail address from which the incoming mail was actually transmitted. When mail is to be sent to a mail address other than the original mail address, the mail must be created from scratch.

However, as shown in the present embodiment, the mail key relating to the present invention has the advantage that it enables a mail address to be selected easily with a simple operation to create an outgoing mail.

<1-3. When the Web Key is Pressed>

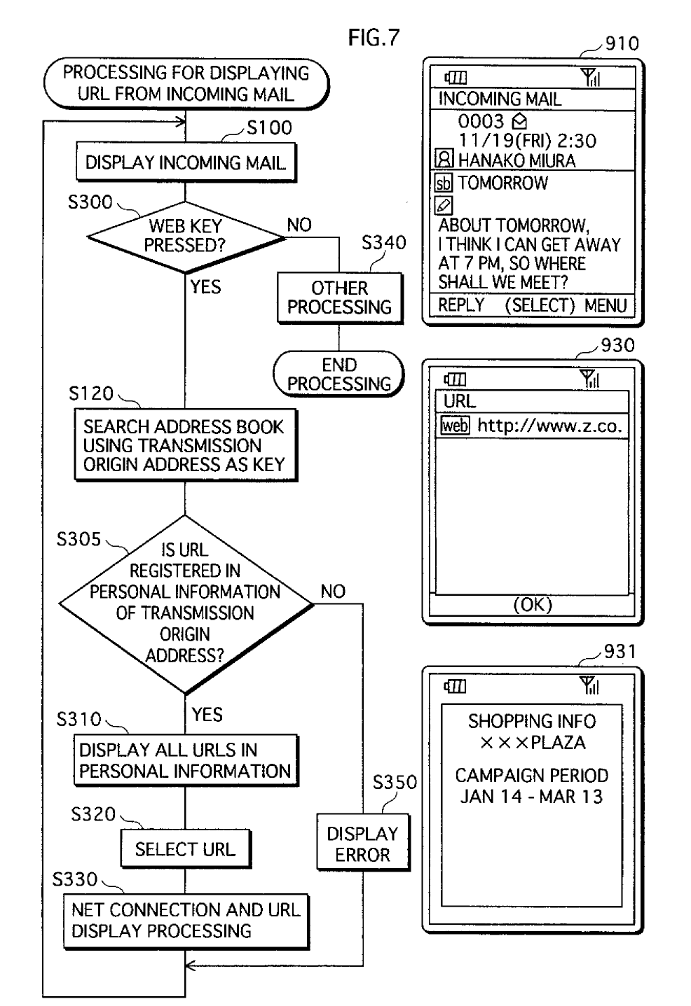

FIG. 7 is a flowchart showing processing in the case of the web key 230 being pressed when an incoming mail is being displayed.

Here, the incoming mail is either a mail received by the mail transmission/reception function unit 600 or a mail received by the short message transmission/reception function unit 700.

First the case of the mail being a mail received by the mail transmission/reception function unit 600 is described.

The user performs an operation to display the incoming mail, and the incoming mail instructed by the user is displayed (step S100, screen 920).

The processing to display the incoming mail is the same as the processing at step S100 of FIG. 5.

In this state, the user presses the web key 230 (step S300: YES).

The key operation detection unit 200 detects that the web key 230 has been pressed, and notifies the control unit 100 that the function assigned to the pressed key is the web access function.

If any other key is pressed, the key operation detection unit 200 notifies the control unit 100 of the processing allocated to the pressed key (step S300: NO), and the processing is executed (step S340).

The control unit 100 receives notification that the web access function has been instructed by the user. The control unit 100 then notifies the address book search unit 400 of the transmission origin mail address 612 of the currently displayed incoming mail, and issues a request to the address book search unit 400 to search for a corresponding URL.

Having received the search request, the address book search unit 400 performs a search of the address book stored in the address book storage unit 410 using the notified transmission origin mail address 612 as a key (step S120). The address book search unit 400 then selects the personal information 420 that includes a mail address the same as the transmission origin mail address 612. The address book search unit 400 retrieves all URLs from the selected personal information 420 (step S305: YES), and returns the retrieved one or more URLs to the control unit 100.

As one example, when the transmission origin mail address is “aaa@bbb.com”, the personal information 420 having “038” as the registration number 421 is selected, and one URL, namely “http://www.z.co.jp/yyy/x.html”, is retrieved.

The control unit 100 provides the URL received from the address book search unit 400 to the display unit 300, and requests the display unit 300 to display the URL. As this time, the control unit 100 stores the URL in the working memory.

Having received the URL display request, the display unit 300 displays the URL on the display 310 (step S310, screen 930).

The user focuses on one of the displayed URLs and presses the OK key (step S320).

The key operation detection unit 200 detects that the OK key has been pressed, and notifies the control unit 100 of the press and which number URL is being focused on.

The control unit 100 receives the notification, and retrieves the URL that was being focused on from the working memory. The control unit 100 then notifies the web access unit 800 of the retrieved URL, and issues an access request to the web access unit 800.

Having received the access request, the web access unit 800 connects to the Internet, and performs processing to perform display corresponding to the received URL (step S330, screen 931).

When the user has finished viewing the webpage, the user presses the end key. The key operation detection unit 200 detects the press, and notifies the control unit 100 to that effect. The control unit 100 receives the notification, and displays the incoming mail (step S100).

Note that when the address book search unit 400 is unable to select the personal information 420, or when URLs are not registered in the selected personal information, the address book search unit 400 notifies the control unit 100 to this effect, and the control unit 100 issues a request to the display unit 300 to display a message to this effect.

The display unit 300 receives the message display request, and displays an error message on the display 310 (step S350). Although not illustrated, the displayed screen is similar to that shown by the screen 912 in FIG. 5.

Next, a description is given of a case in which the incoming mail is mail received by the short message transmission/reception function unit 700.

The difference when the incoming mail is mail received by the short message transmission/reception function unit 700 instead of mail received by the mail transmission/reception function unit 600 is that the control unit 100 stores a telephone number instead of a mail address, and it is the telephone number, not the mail address, that the address book search unit 400 uses as a key when searching the address book (step S120).

<2. When an Outgoing Mail is Designated>

The following describes processing in cases of each of keys 210, 220 and 230 being pressed when an outgoing mail is designated.

<2-1. When the Call Key is Pressed>

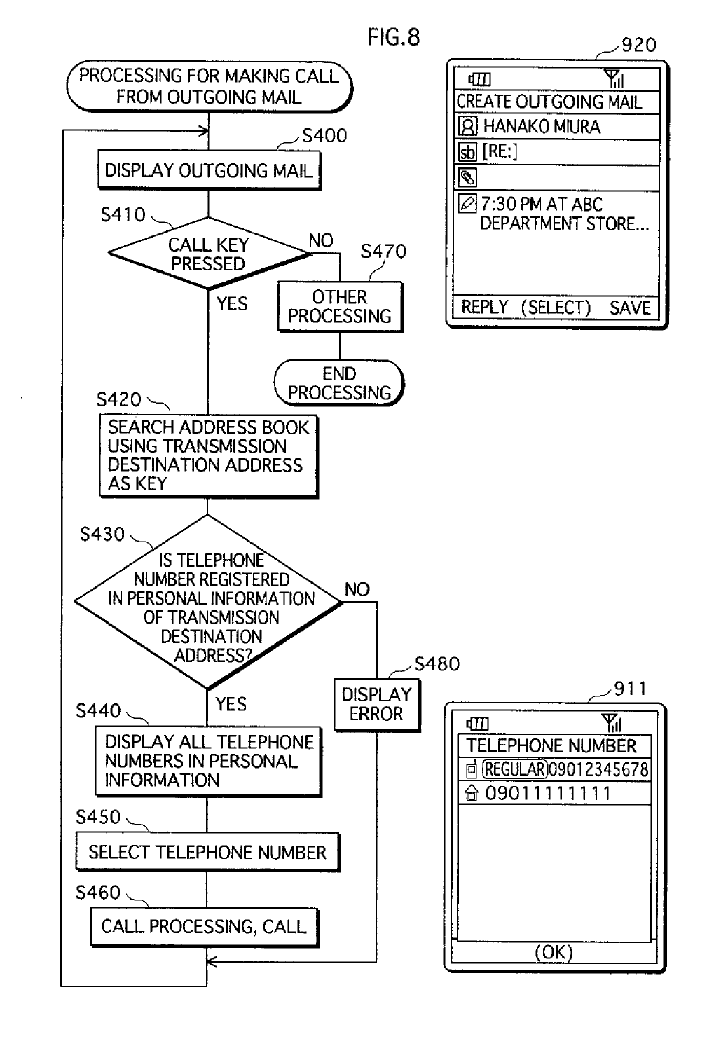

FIG. 8 is a flowchart showing processing in the case of the call key 210 being pressed when an outgoing mail is being displayed.

The processing here is almost the same as the case of the call key 210 being pressed when displaying an incoming mail that was described with use of FIG. 5. A difference is that instead of the address book search unit 400 searching the address book using the transmission origin mail address 612 of the reception information 610 of the incoming mail as a key, the address book search unit 400 searches the address book using the transmission destination mail address of the transmission destination information 650 of the outgoing mail as a key.

A brief description is given of this processing.

The display unit 300 displays the outgoing mail according to a user operation (step S400, screen 920), and in this state, the user presses the call key 210 (step S410: YES). At this time, the control unit 100 stores the transmission destination mail address. If any other key is pressed, processing corresponding to the pressed key is executed (step S410: NO, step S470).

Upon the call key 210 being pressed, the address book search unit 400, according to a request from the control unit 100, searches the address book using the transmission destination mail address as a key (step S420), and retrieves one or more telephone numbers (step S430). When there are no telephone numbers to retrieve, the display unit 300 displays an error message (step S480). Although not illustrated, the screen that is displayed is in the same format as the screen 912 shown in FIG. 5.

When there are a plurality of transmission destination mail addresses, the address book search unit 400 performs retrieval with respect to all of these mail addresses. The display unit 300 displays the retrieved one or more telephone numbers (step S440, screen 911). When there are a plurality of transmission destinations, telephone numbers equal in number to the people are displayed in pages such as displayed in the screen 922 in FIG. 6, which can be flipped through to select a telephone number.

One of the telephone numbers is selected by the user (step S450), and call processing is performed (step S460).

In the case of the outgoing mail being a mail transmitted by the short message transmission/reception function unit 700, the control unit 100 stores a telephone number instead of a mail address, and the key used by the address book search unit 400 to search the address book is the telephone number, not the mail address (step S420).

<2.2 When the Mail Key is Pressed>

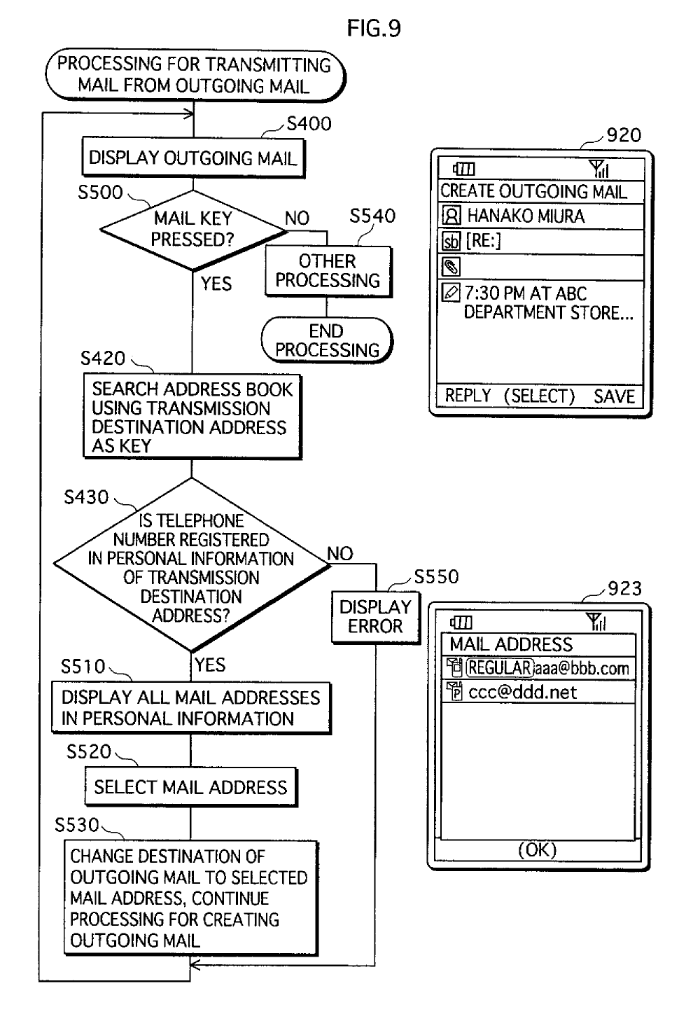

FIG. 9 is a flowchart showing processing in the case of the mail key 220 being pressed when an outgoing mail is being displayed.

The processing here is almost the same as the case of the call key 210 being pressed when displaying an outgoing mail that was described with use of FIG. 8. A difference is that instead of retrieving telephone numbers from the address book, the address book search unit 400 retrieves mail addresses. Processing to change the destination of a mail is performed based on the retrieved mail addresses, instead of call processing.

A brief description is given of this processing.

The display unit 300 displays the outgoing mail according to a user operation (step S400, screen 920), and in this state, the user presses the mail key 220 (step S500). At this time, the control unit 100 stores the transmission destination mail address.

If any other key is pressed, processing corresponding to the pressed key is executed (step S540).

Upon the mail key 220 being pressed, the address book search unit 400, according to a request from the control unit 100, searches the address book using the transmission destination mail address as a key (step S420), and retrieves one or more mail addresses (step S430). When there are no mail addresses to retrieve, the display unit 300 displays an error message (step S550). Although not illustrated, the screen that is displayed is in the same format as the screen 912 shown in FIG. 5.

When there are a plurality of transmission destination mail addresses, the address book search unit 400 performs retrieval with respect to all of these mail addresses. The display unit 300 displays the retrieved one or more mail addresses (step S50, screen 923). When there are a plurality of transmission destinations, mail addresses equal in number to the people are displayed in pages such as displayed in the screen 922 in FIG. 6, which can be flipped through to select a mail address.

One mail address is selected by the user with respect to each transmission destination (step S520), and the transmission destination mail address is changed to the selected mail address (step S530). When there are a plurality of transmission destinations, the user selects a mail address with respect to each one, and changes each mail address.

For instance, when the transmission destination of the outgoing mail being created is “aaa@bbb.com”, the transmission destination address can be changed to “ccc@ddd.net” by performing the described processing by pressing the mail key.

In the case of the outgoing mail being a mail transmitted by the short message transmission/reception function unit 700, the control unit 100 stores a telephone number instead of a mail address, and the key used by the address book search unit 400 is the telephone number, not the mail address (step S420).

<2-3. When the Web Key is Pressed>

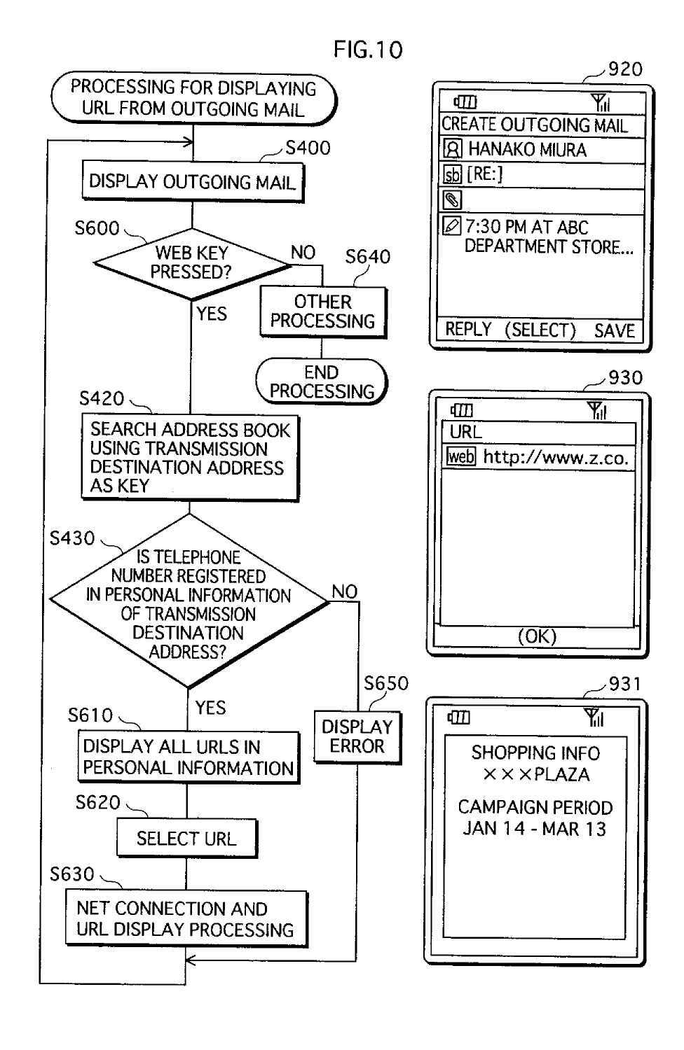

FIG. 10 is a flowchart showing processing in the case of the web key 230 being pressed when an outgoing mail is being displayed.

The processing here is almost the same as the case of the web key 230 being pressed when displaying an incoming mail that was described with use of FIG. 7. A difference is that instead of searching the address book using the transmission origin mail address 612 of the reception information of the incoming mail as a key, the address book search unit 400 uses the transmission destination mail address of the transmission destination information 650 of the outgoing mail as the key.

A brief description is given of this processing.

The display unit 300 displays the outgoing mail according to a user operation (step S400, screen 920), and in this state, the user presses the web key 230 (step S600). At this time, the control unit 100 stores the transmission destination mail address.

If any other key is pressed, processing corresponding to the pressed key is executed (step S640).

Upon the web key 230 being pressed, the address book search unit 400, according to a request from the control unit 100, searches the address book using the transmission destination mail address as a key (step S420), and retrieves one or more URLs (step S430). When there are no URLs to retrieve, the display unit 300 displays an error message (step S650). Although not illustrated, the screen that is displayed is in the same format as the screen 912 shown in FIG. 5.

When there are a plurality of transmission destination mail addresses, the address book search unit 400 performs retrieval with respect to all of these mail addresses. The display unit 300 displays the retrieved one or more URLs (step S610, screen 930). When there are a plurality of transmission destinations, URLs equal in number to the people are displayed in pages such as displayed in the screen 922 in FIG. 6, which can be flipped through to select a URL.

One of the URLs is selected by the user (step S620). The web access unit 800 connects to the Internet, accesses the selected URL, and displays a web page (step S630).

In the case of the outgoing mail being a mail transmitted by the short message transmission/reception function unit 700, the control unit 100 stores a telephone number instead of a mail address, and the key used by the address book search unit 400 to search the address book is the telephone number, not the mail address (step S420).

<Supplementary Remarks>

Although the present invention has been described based on the above embodiment, the mobile terminal can be partially modified, and the present invention is by no means limited to the above embodiment. Specifically:

(1) In the described embodiment, when displaying an incoming mail, a reply mail can be created by pressing the mail key (see FIG. 6). However, a reply mail may be created as a short message when a long press of the mail key is performed.

In this case, the address book is searched using the mail address, one or more telephone numbers retrieved from personal information are displayed, and a request to create a reply mail is issued to the short message transmission/reception unit 700 based on the selected telephone number.

(2) In the present embodiment, functions allocated to each key are executed by pressing the particular key. However, execution of the functions may be instructed from a menu or the like.

(3) In the present embodiment, a telephone number or the like is displayed as a list even when there is only one (see FIG. 7, screen 937). However, in this case of there being only one telephone number or the like, the function may be executed based on the one telephone number.

For example, when only one telephone number has been retrieved, call processing may be performed as soon as the call key is pressed.

Furthermore, even in the case of plural telephone numbers or the like, it may be determined in advance which is to be selected, and this may be changed automatically according to the time of day. In this case, for instance, a unit may be provided for receiving input of information including which telephone number or the like the user will select, and which telephone number of the like will be selected in which part of the day. The input information is stored, and the control unit 100 selects a telephone number or the like according to a press of a key, and issues instruction to each function unit accordingly.

(4) A program for causing a CPU to execute the control processing (see FIG. 1, etc.) for realizing the function of the mobile terminal shown in the present embodiment may be distributed recorded on a recording medium, via various communication paths, or in other ways. The recording medium may, for instance, be an IC card, an optical disc, a flexible disk, a ROM, or a flash memory. The distributed program is used by being stored in a memory readable by a CPU in a device, and the functions of the mobile terminal shown in the above embodiment are realized by the CPU executing the program.

### INDUSTRIAL APPLICABILITY

The present invention is effective as a technique for a mobile telephone having a mail transmission/reception function.

1. A mobile terminal having a plurality of functions including a mail function, and having a plurality of keys, each of which a different one of the functions is allocated to, the mobile terminal comprising:
an address book operable to store, in correspondence, destination information pieces and related information pieces, each destination information piece being information at least identifying an opposite party of mail, and each related information piece being information relating to the opposite party identified by the corresponding destination information piece; and
a retrieval unit operable to, when a designation of one of (i) a mail that has been received, (ii) a mail that has been transmitted, and (iii) a mail that is to be transmitted is received and any one of the keys is pressed, retrieve from the address book, one or more related information pieces in correspondence with one of the destination information pieces that identifies an opposite party of the designated mail.

2. The mobile terminal of claim 1, further comprising:
a display unit operable to display at least one of the retrieved related information pieces.

3. The mobile terminal of claim 2, further comprising:
a designation unit operable to designate one of the displayed related information pieces; and
a control unit operable to cause commencement of a function allocated to the pressed key, based on the designated related information piece.

4. The mobile terminal of claim 1, further comprising:
a control unit operable to cause commencement of a function allocated to the pressed key, based on the one or more retrieved related information pieces.

5. The mobile terminal of claim 3 or 4, wherein
the function allocated to the pressed key is a call initiation function,
each of the one or more related information pieces retrieved by the retrieval unit is a telephone number, and
the control unit causes commencement of the call initiation function to initiate a call to one of the retrieved telephone numbers.

6. The mobile terminal of claim 3 or 4, wherein
the function allocated to the pressed key is a mail transmission function,
each of the one or more related information pieces retrieved by the retrieval unit is a mail address, and
the control unit causes commencement of the mail transmission function to transmit a mail to one of the retrieved mail addresses.

7. The mobile terminal of claim 3 or 4, wherein
the function allocated to the pressed key is a short message function for sending a predetermined type of mail,
each of the one or more related information pieces retrieved by the retrieval unit is a telephone number, and
the control unit causes commencement of the short message function to transmit the predetermined type of mail to one of the retrieved telephone numbers.

8. The mobile terminal of claim 3 or 4, wherein
the function allocated to the pressed key is a web page display function,
each of the one or more related information pieces retrieved by the retrieval unit is an address of a web page, and
the control unit causes commencement of the web display function to display a web page of one of the extracted addresses.

9. A mobile terminal having a plurality of functions including a mail function, and having a plurality of keys, each of which a different one of the functions is allocated to, the mobile terminal comprising:
an address book operable to store, in correspondence, at least one or more mail addresses and one or more telephone numbers; and
a retrieval unit operable to, when a designation of one of (i) a mail that has been received, (ii) a mail that has been transmitted, and (iii) a mail that is to be transmitted is received and any one of the keys is pressed, retrieve from telephone numbers in the address book, a telephone number in correspondence with a mail address of the designated mail.
